(19) United States
(12) Patent Application Publication
(10) Pub. No.: US 2010/0156409 A1
(43) Pub. Date: Jun. 24, 2010

(54) METHOD FOR DETERMINING THE CONTENT OF LIQUID AND SOLID PHASE COMPONENTS IN HYDROCARBON MIXTURE

(75) Inventors: Ivan Vladimirovich Nikolin, Moscow (RU); Nikolay Viktorovich Shkalikov, Kazan (RU); Vladimir Dmitrievich Skirda, Kazan (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Cambridge, MA (US)

(21) Appl. No.: 12/636,978

(22) Filed: Dec. 14, 2009

(30) Foreign Application Priority Data
Dec. 12, 2008 (RU) 2008148990

(51) Int. Cl. G01V 3/14

(52) U.S. Cl. 324/303

(57) ABSTRACT

The method for a hydrocarbon mixture composition determination includes the collection of at least one sample of the hydrocarbon mixture. For this sample, a nuclear magnetic resonance method is used for measuring series of hydrocarbon mixture's free inductance decrement curves within a temperature range of −150° C. to +150°. Each free inductance decrement curve is then used to determine the solid component fraction Pₛ in the NMR ¹H signal at a temperature, at which this value was measured. The received values are then used to plot a temperature dependence of the solid component fraction Pₛ in the NMR ¹H signal and, based on the Pₛ value variation (ΔPₛᵢ), caused by a phase transition of the i^{th} component due to a heating or cooling process and the content of solid and/or liquid phase components in the hydrocarbon mixture is defined by attributing the ΔPₛᵢ value to the associated components of the mixture.

### FIELD OF INVENTION

This disclosure relates to geology, geochemistry, oil refining and petroleum chemistry, i.e. to the determination of the content of liquid and solid phase components in hydrocarbon mixtures.

Information about the content of liquid and solid phase components in hydrocarbon mixtures provides opportunities for an in-depth understanding of mixture properties. In particular, information about oil composition notably enlarges opportunities for oil production and refining optimization. Given the present status of technology development, this information may not always be available due to the complexity, uncertainty and high cost of advanced methods applied for determining the concentration of some oil components. Whilst light fractions can be separated through distillation and rectification processes, concentrations of the most heavy oil components (paraffins, resins and asphaltenes) are not that easy to be defined.

Embodiments of the present invention allow a rather quick determination of the content of liquid and solid phase components in hydrocarbon mixtures. In the claimed method, sophisticated chemical processing operations are not required.

### BACKGROUND OF THE INVENTION

Current methods applied for determining the content of liquid and solid phase components in hydrocarbon mixtures have been standardized in different GOSTs (e.g., GOST 2070-82) and international standards (e.g., ASTM D-86-93) and are based on the application of 4 major methods:
thermal methods (refining, rectification, thermal diffusion);
absorption methods (gas chromatography, liquid chromatography);
spectral methods (IR- and UV-spectrometry, atomic absorption spectrometry, mass-spectrometry); and
chemical methods (chemical analysis).

Some of these methods allow hydrocarbons group separation in a rather pure form (chromatography), others allow hydrocarbons group separation only in the form of concentrates (selective dissolution) and still others allow hydrocarbons group separation only for the same group (clear rectification, crystallization). However, there are some methods available, which enable determination, with a high accuracy, the content of structural elements of hydrocarbons of different groups and directly in a fuel, without its separation (spectral analysis).

Three GOSTs for petroleum product composition determination through a gradual refining are applicable in the FSU. One of these is an advanced procedure for defining the content of liquid and solid phase components in hydrocarbon mixtures as per GOST 2177-99, “Petroleum Products Methods for Determination of Distillation Characteristics”, Interstate Council for Standardization, Metrology and Certification, Minsk, 28 May 1999. In accordance with this method, the composition of both raw oil and processed oil light products (benzene, kerosene, straw factions) are defined through oil refining process. While defining a fractional composition, oil and petroleum products are refined in a standard unit under certain conditions; and once this is complete a chart of boil-off of individual hydrocarbons and their mixtures is plotted in the coordinate system (temperature vs. strip). When petroleum products are heated, low-boiling highly volatile components are first converted in the vapor phase. As far as low-boiling components are distillated, the residue is enriched with high-boiling components. The stripping results are displayed as a table or chart (boiling temperature vs. strip (%)). Lines in this chart are labeled as distillation curves or fractional composition curves. In case of an accurate separation of a mixture (i.e., if laboratory periodic rectification methods are used), true boiling temperature curves are obtained; in case of inaccurate separation, specific boiling temperature curves (standard distillation curves) are obtained. True boiling temperature curves are of primary importance. These curves are used to define fractional composition of raw oil, calculate physico-chemical and operating properties of petroleum products and oil mixture refining and rectification process parameters. The difference in physico-chemical properties of hydrocarbons is used for fuel separation into narrow groups of hydrocarbons as well as for identification of these groups, whilst the additivity of some properties is used for calculation of quantitative content of hydrocarbon groups in the mixture. Disadvantages of all standard distillation methods are as follows: weak convergence between different analyzers; measurement of vapor temperatures near a vapor discharge tube instead of the true boiling temperature measurement; long duration of the process; large volume of the sample; and high labor intensity.

### SUMMARY OF THE INVENTION

Embodiments of the present invention develop a simple, quick and effective method for defining the content of liquid and solid phase components in hydrocarbon mixtures. The technical result to be reached through the implementation of the claimed invention is to accelerate the process of determination of the content of liquid and solid phase components in hydrocarbon mixtures and to eliminate sophisticated mixture processing operations as well as to simplify the process of determination of the content of liquid and solid phase components in hydrocarbon mixtures.

The above-mentioned technical result is reached through the implementation of the following process: at least one sample of the hydrocarbon mixture is collected; using the collected sample, a nuclear magnetic resonance method is used for measuring a series of hydrocarbon mixture's free inductance decrement curves within a temperature range of −150° C. to +150° C.; each free inductance decrement curve is then used to determine the solid component fraction Pₛ in the ¹H signal of the nuclear magnetic resonance (NMR) at a temperature at which this value was measured; the received values are then used to plot a temperature dependence of the solid component fraction Pₛ in the NMR ¹H signal and, based on the Pₛ value variation (ΔPₛᵢ), caused by a phase transition of the i^{th} component due to a heating or cooling process, the content of solid and/or liquid phase components in the hydrocarbon mixture is defined by attribution of the ΔPₛᵢ value to the associated components of the mixture.

### DETAILED DESCRIPTION OF THE PREFERRED EMBODIMENTS

The invention is explained by the drawings, wherein

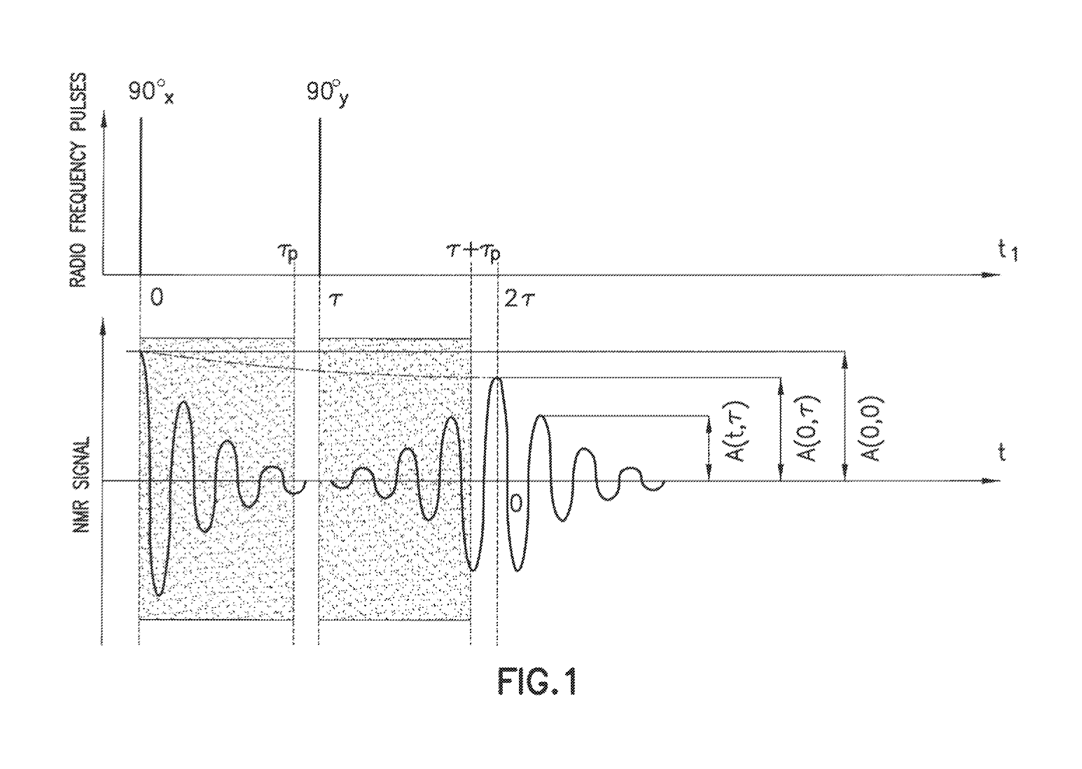

FIG. 1 shows a double-pulse sequence of a solid-body echo. The crosshatched area corresponds to the paralyzation time of the NMR equipment inlet path.

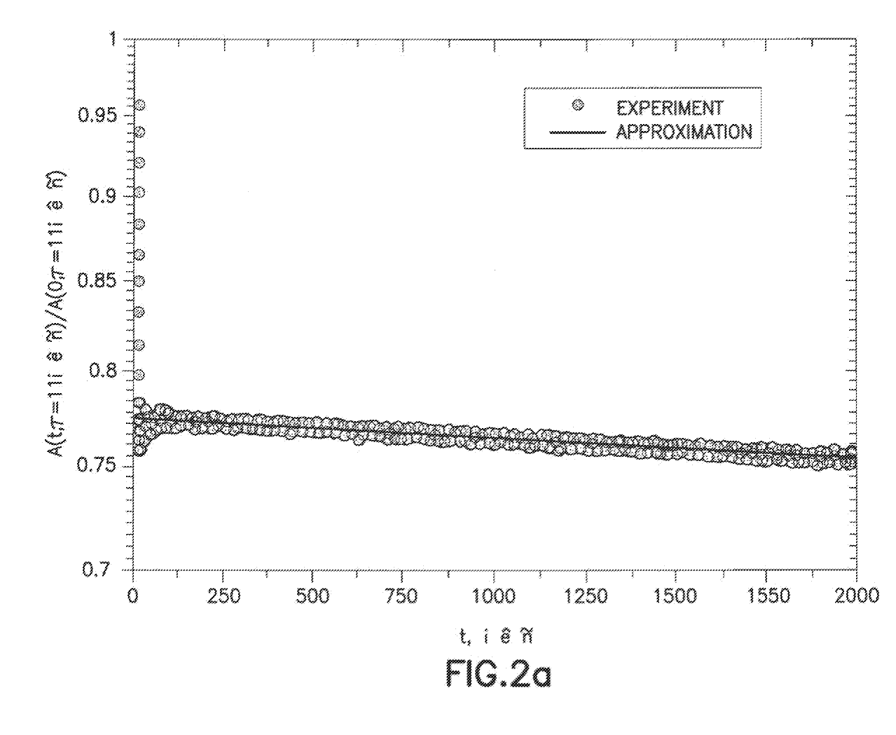

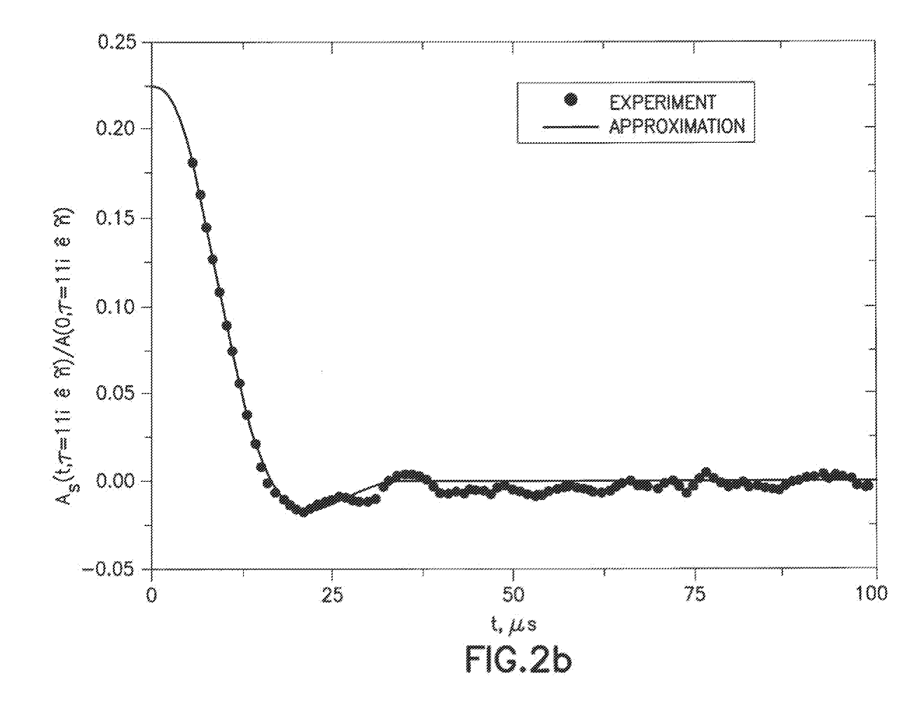

FIG. 2 a) shows a shape of the solid-body echo's NMR ¹H signal, recorded at the time τ=11 μs for a mixture comprising 30% tetracosane (C₂₄H₅₀) and 70% decane (C₁₀H₂₂) at a temperature of −10° C. The continuous straight line is a result of approximation of the signal, related to the liquid phase, using the formulas (1).

FIG. 2 b) shows a shape of the solid-body component's NMR ¹H signal, which was received by deducting the liquid-body component's NMR ¹H signal from the solid-body echo's NMR ¹H full signal of the mixture comprising 30% tetracosane (C₂₄H₅₀) and 70% decane (C₁₀H₂₂) at a temperature of −10° C. The continuous straight line is a result of approximation of the solid-body component's NMR ¹H signal, using the formulas (I).

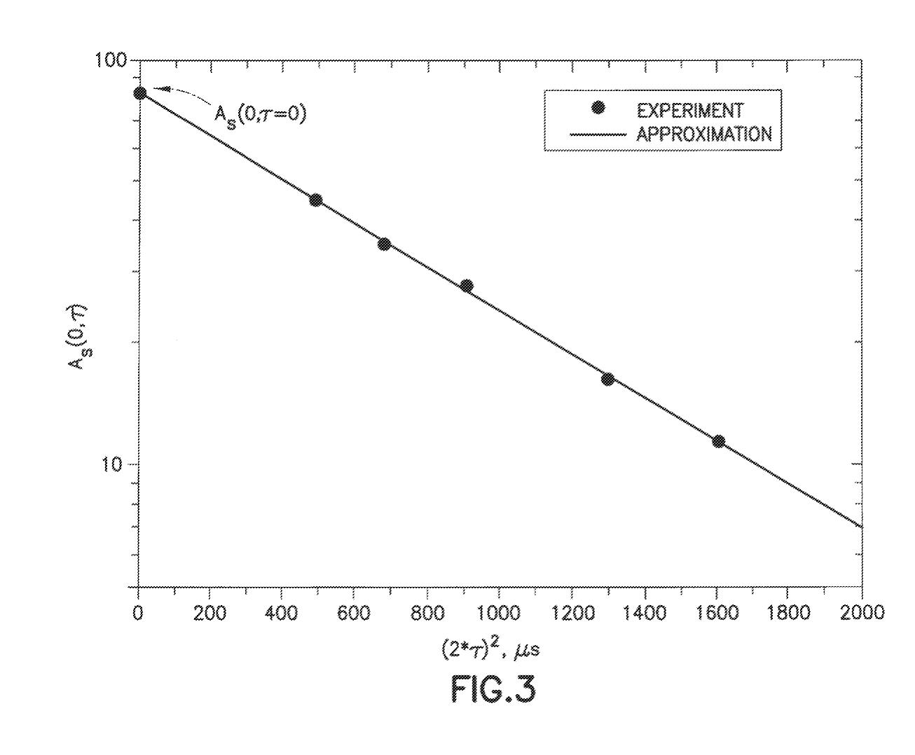

FIG. 3 shows the dependence of the amplitude Aₛ(0,τ) of the solid-body component in the solid-body echo's NMR ¹H signal of the mixture comprising 30% tetracosane (C₂₄H₅₀) and 70% decane (C₁₀H₂₂) at a temperature of −10° C., vs. the square of the double time τ. The straight line is a result of a linear approximation of experimental values. The arrow points to the point of intersection of the straight line and the ordinate axis at τ=0 μs.

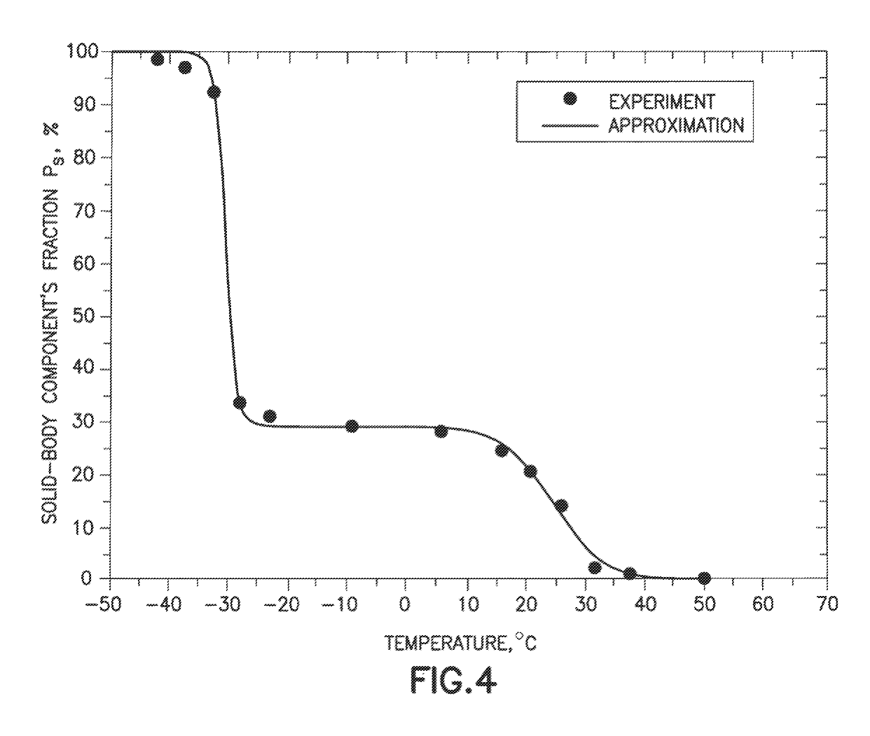

FIG. 4 shows a temperature dependence of the solid-body component Pₛ fraction in the NMR ¹H signal of the mixture comprising 30% tetracosane (C₂₄H₅₀) and 70% decane (C₁₀H₂₂). The continuous curve is a result of approximation of experimental points, using the formula (3).

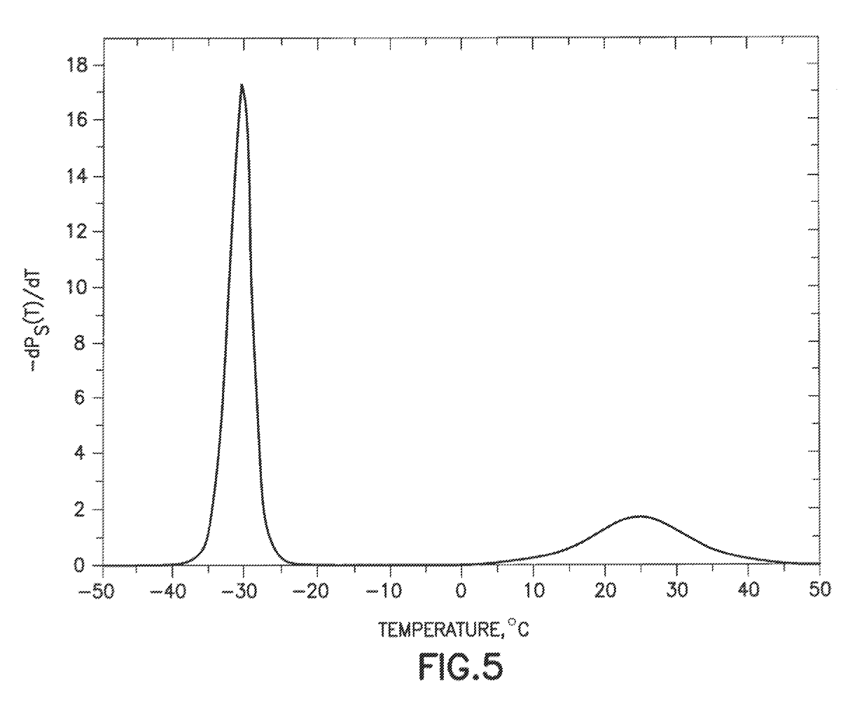

FIG. 5 shows a temperature dependence −dPₛ(T)/dT for the mixture comprising 30% tetracosane (C₂₄H₅₀) and 70% decane (C₁₀H₂₂).

This invention relates to the method for defining the content of liquid and solid phase components in hydrocarbon mixtures, which includes the following operations: at least one sample of the hydrocarbon mixture is collected; for the collected sample, a nuclear magnetic resonance method is used for measuring a series of hydrocarbon mixture's free inductance decrement curves within a temperature range of −150° C. to +150° C.; each free inductance decrement curve is then used to determine the solid component fraction Pₛ in the NMR ¹H signal at a temperature, at which this value was measured; the received values are then used to plot a temperature dependence of the solid component fraction Pₛ in the NMR ¹H signal and, based on the Pₛ value variation (ΔPₛᵢ), caused by a phase transition of the i^{th} component due to a heating or cooling process, the content of solid and/or liquid phase components in the hydrocarbon mixture is defined by attributing the ΔPₛᵢ value to the associated components of the mixture.

Nuclear magnetic resonance (NMR) is a physical phenomenon which is based on magnetic properties of the atomic nucleus. NMR on hydrogen atomic nucleus is more broadly used, since this isotope is characterized by the utmost sensitivity. The NMR method is used to study magnetic nucleus by orienting their magnetic moments in a very strong external magnetic field and by disturbing this orientation of the spins, using a resonance electromagnetic field. The response of the nuclear magnetic moments to the electromagnetic disturbance is a phenomenon, which is applied in the nuclear magnetic resonance spectroscopy and in the magnetic resonance tomography.

The process, which is called relaxation, is characterized by a return of nuclear moments in a thermodynamically equilibrium state in the external magnetic field. This process is called longitudinal relaxation, in which the longitudinal relaxation time T₁ characterizes a mean time required for individual nuclei to return to its equilibrium state. Upon completion of the relaxation process, the system can be disturbed once again by the resonance electromagnetic field, since it rests in the initial equilibrium state.

Precessional magnetic moments of nucleuses in a plane perpendicular to the external magnetic field are disoriented against each other with time; as a result, NMR signal disappear. This process is called lateral relaxation. In practice, the lateral relaxation time T₂ characterizes the time, within which a NMR signal is observed—free inductance decrement (FID).

The FID signal of multi-phase systems (including oil) is a superposition of signals, which can be divided by relaxation time. The FID curve of the hydrocarbon mixture's liquid components is characterized by a Lorentzian line shape or their sum with the lateral relaxation time T₂ values of above 100 μs, whilst the FID curve of the hydrocarbon mixture's solid components is typically characterized by a Gaussian line shape with the lateral relaxation time T₂ values of below 10 μs. Therefore, the time of lateral relaxation of NMR signal for the solid component is much less than the relaxation time for liquid-phase components. This circumstance may be used for splitting general FID curve in parts, associated only with solid-body components and only with liquid-phase components of the hydrocarbon mixture and, correspondingly, for defining their fractions.

In embodiments of the present disclosure we suggest analyzing only solid-body component fraction in the NMR 1H signal and its dependence from temperature. Since many NMR methodologies exist for metering the solid-body component fraction in the NMR 1H signal, it does not matter which one to apply for this purpose. One of possible methodologies for metering the solid-body component fraction in the NMR 1H signal is a double-pulse sequence-solid-body echo (90° x-τ-90° y-τ). FIG. 1 illustrates the shape of a double-pulse sequence-solid-body echo that allows the recording of the solid-body echo signal.

An embodiment of the present disclosure allows the determination of the content of liquid and solid phase components in hydrocarbon mixtures, e.g., oils, using the NMR method for this purpose. The NMR method allows the information about solid/liquid phase ration in hydrocarbon mixtures to be received. To define the content of hydrocarbon mixture components (light fractions, oil fractions, paraffins, resins and asphaltenes), it is necessary to analyze the dependence of the oil's solid-body component fraction Pₛ in the NMR ¹H signal in a broad range of temperatures, in which the oil's solid-body component fraction Pₛ in the NMR ¹H signal varies virtually from 0 to 100%. Since it is known that certain phase transitions of the 1^{st} (melting and crystallization) and 2^{nd} (vitrification) types are attributable to each component of hydrocarbon mixtures (e.g., oil), then the hydrocarbon mixture components can be distinguished from each other by temperatures of phase transitions occurring in these components. Therefore, while analyzing a temperature dependence of the oil's solid-body component fraction Pₛ in the NMR ¹H signal in a temperature range of −150° C. to +150° C., it is possible to find a correspondence between phase transitions and oil components and, as a result, to define the content of each component of hydrocarbon mixtures (e.g., oil)—light fractions, oil fractions, paraffins, resins and asphaltenes. Since major oil components make their contribution to the oil's solid-body component fraction in the NMR ¹H signal in different temperature ranges, in embodiments of the present disclosure we suggest to distinguish oil components from each other by phase transition temperatures, taking into account the following experimental facts:

1) at the atmospheric pressure, asphaltenes make their contribution to the oil's solid-body component fraction in the NMR ¹H signal at temperatures up to 150° C., and even at higher temperatures;
2) at the atmospheric pressure, benzene and spirit-benzene resins may contribute to the oil's solid-body component fraction in the NMR ¹H signal at temperatures not higher than 140° C.;
3) generally, normal paraffins and isoparaffins when heated stop making their contribution to the oil's solid-body component fraction in the NMR ¹H signal in a temperature range of 20° C. to 90° C.;
4) other hydrocarbon components of oil—light fractions and oil fractions—may contribute to the oil's solid-body component fraction in the NMR ¹H signal at temperatures below 20° C. Therefore, by measuring a temperature dependence of the solid-body component fraction Pₛ (%) in the NMR ¹H signal in a wide temperature range of −150° C. to +150° C., it is possible to determine the content of liquid and solid phase components in hydrocarbon mixtures, e.g., raw oil.

A NMR relaxometer is used for defining the solid-body component fraction Pₛ in the NMR ¹H signal of hydrocarbon mixtures, which is characterized by a certain paralyzation time τₚ of the intake path. At a given temperature to be maintained with an accuracy of not less than ±0.5° C., a hydrocarbon mixture's solid-body echo signal A(t,τ) of the hydrocarbon mixture is registered, using the pulse sequence solid-body echo for this purpose (ref. to FIG. 1). Generally, the solid-body echo signal A(t,τ) is a function of time interval τ between radio frequency pulses and time t, counted by the time 2*τ after the first radio frequency pulse was sent. Also, the time interval τ between radio frequency pulses cannot be less than the paralyzation time τₚ of the NMR receiving path. Signal A(t,τ) of solid-body echo of a multiphase system is similar to the FID signal and is generally described as follows:

$$A ( t , τ ) = {A}_{1} ( t ) + {A}_{s} ( t , τ ) , \\ {A}_{1} ( t ) = {\sum }_{i} {A}_{1 i} ( 0 ) \cdot exp ( - \frac{t}{{T}_{21 i}} ) , \\ {A}_{s} ( t , τ ) = {A}_{s} ( 0 , τ ) \cdot exp ( - {( \frac{t}{{T}_{2 s}} )}^{2} ) \cdot \frac{sin ( a \cdot t )}{a \cdot t} , \qquad ( 1 )$$

where A₁ᵢ(0)—amplitude of NMR ¹H signal of the i^{th} liquid component at a maximum value of the solid-body echo; Aₛ(0,τ)—amplitude of NMR ¹H signal of the solid-body component at a maximum value of the solid-body echo, which depends on time interval τ between radio frequency pulses; T₂₁ᵢ—lateral relaxation time for the i^{th} liquid component of NMR ¹H signal; T₂ₛ—lateral relaxation time for solid-body component of NMR ¹H signal; a—parameter that characterizes beating of the solid-body component's NMR ¹H signal.

Thereafter, the A(t,τ) signal of the hydrocarbon mixture's solid-body echo is decomposed to exponential components by experimental point approximation, using the formula (1), and amplitude of the NMR ¹H signal Aₛ(0,τ) of the solid-body component at the given time τ. Then, the dependence of the solid-body component's NMR ¹H signal Aₛ(0,τ) vs time τ is determined and extrapolated to the time τ=0 μs. As a result, the value of the solid-body component's NMR ¹H signal amplitude is calculated. The solid-body component fraction Pₛ in the NMR ¹H signal of hydrocarbon mixtures at a given temperature is defined in accordance with the following formula:

$${P}_{s} = \frac{{A}_{s} ( t = 0 , τ = 0 )}{A ( t = 0 , τ = 0 )} \cdot 100 \% , \\ {P}_{1 i} = \frac{{A}_{1 i} ( t = 0 )}{A ( t = 0 , τ = 0 )} \cdot 100 \% , \\ {\sum }_{i} {P}_{1 i} + {P}_{s} = 100 \% , \qquad ( 2 )$$

where P₁ᵢ—fraction of i^{th} liquid component in hydrocarbon mixture's NMR ¹H signal.

The next step is to analyze a temperature dependence of the Pₛ fraction. The temperature dependence of the solid-body component's fraction Pₛ in hydrocarbon mixture's NMR ¹H signal is described as follows:

$${P}_{s} ( T ) = 100 - {\sum }_{i = 1}^{N} \frac{Δ {P}_{si}}{exp ( - \frac{T - {T}_{0 i}}{{w}_{i}} ) + 1} , \qquad ( 3 )$$

where ΔPₛᵢ—change in fraction Pₛ due to a phase transition of the i^{th} component of the mixture as a result of heating or cooling; T₀ᵢ—average phase transition temperature; wᵢ—parameter that characterizes a temperature range, within which the phase transition takes place; N—number of phase transitions, which typically coincides with the number of components in the mixture. By approximating temperature dependence of the solid-body component's fraction Pₛ in hydrocarbon mixture's NMR ¹H signal using equation (3), it's possible to find the correspondence between phase transitions, which take place in the temperature range of −150° C. to +150° C., and hydrocarbon mixture components, which allows us to determine the content of each component or some components in the mixture, by attributing ΔPₛᵢ values to the associated components of the mixture.

For providing a more visible interpretation of a temperature dependence of the solid-body component's fraction Pₛ in hydrocarbon mixture's NMR ¹H signal, the temperature dependence of the first derivative from Pₛ(T) is plotted. The dependence −dPₛ(T)/dT for hydrocarbon mixtures is described by the following equation:

$$- \frac{d {P}_{s} ( T )}{d T} = {\sum }_{i = 1}^{N} \frac{Δ {P}_{si}}{{w}_{i} \cdot ( exp ( - \frac{T - {T}_{0 i}}{{w}_{i}} ) + exp ( \frac{T - {T}_{0 i}}{{w}_{i}} ) + 2 )} . \qquad ( 4 )$$

By plotting the temperature dependence −dPₛ(T)/dT, it is also possible to find the correspondence between the phase transitions, which occur in the temperature range of −150° C. to +150° C., and hydrocarbon mixture components, which makes it possible to define the content of each component or some components in the hydrocarbon mixture, by integrating the obtained function −dPₛ(T)/dT by corresponding temperature ranges of phase transitions.

As an example to illustrate the applicability of the claimed method, the content of liquid and solid phase components in hydrocarbon mixtures by the temperature dependence of the solid-body component's fraction Pₛ in hydrocarbon mixture's NMR ¹H signal for a mixture comprising 30% tetracosane (C₂₄H₅₀) and 70% decane (C₁₀H₂₂) can be determined.

The mechanism of defining the solid-body component's fraction Pₛ in hydrocarbon mixture's NMR ¹H signal for a mixture comprising 30% tetracosane (C₂₄H₅₀) and 70% decane (C₁₀H₂₂) at a temperature of −10° C., which is a mixture of liquid and solid phases can be shown.

FIG. 2 illustrates the deduction of the liquid component's NMR ¹H signal from the full solid-body echo NMR ¹H signal recorded at the time τ=11 μs. In FIG. 2(a), a shape of the solid-body echo full signal A(t, τ=11 μs) is shown in logarithmic coordinates. By approximating experimental points of the solid-body echo signal A(t, τ=11 μs) at the time of above 100 μs as a straight line, shown in FIG. 2(a) as a continuous line, and by extrapolating it to the time t=0 μs, thus defining the amplitude A₁(0) of the liquid component's NMR ¹H signal. FIG. 2(b) depicts a shape of the solid-body's NMR ¹H signal Aₛ(t, τ=11 μs) after the deduction of the liquid component's NMR ¹H signal from the full NMR ¹H signal A(t, τ=11 μs). By extrapolating function Aₛ(t, τ=11 μs), obtained through the approximation of the solid-body component's NMR ¹H signal by using the formula (1) to the time t=0 μs, the amplitude is calculated Aₛ(0,τ) of the solid-body component's NMR ¹H signal. Similar operations can be carried out for the solid-body echo's NMR ¹H signals recorded at the time τ≧τₚ. Then, in logarithmic coordinates, a function is plotted of the amplitude Aₛ(0,τ) of the solid-body component's NMR ¹H signal vs. of the square of the double time τ (ref/to FIG. 3), since in these coordinates this function becomes a linear function. The chart received in such a way is then approximated by a straight line and extrapolated to the time τ=0 μs; thus allowing determination of the value of the amplitude Aₛ(0,0) of the solid-body component's NMR ¹H signal. By substituting the values of amplitudes of NMR ¹H signals of the liquid A₁(0) and solid-body Aₛ(0,0) components to the formula (1) and (2), the solid-body component fraction Pₛ in the NMR ¹H signal for the mixture comprising 30% tetracosane (C₂₄H₅₀) and 70% decane (C₁₀H₂₂) at a temperature of −10° C., which is equal to 29±2% is calculated.

Then, having determined the solid-body component fraction Pₛ in the NMR ¹H signal for the mixture comprising 30% tetracosane (C₂₄H₅₀) and 70% decane (C₁₀H₂₂) in a temperature range which overlaps the Pₛ fraction variation in a range of 0 to 100%, the temperature dependence of the solid-body component fraction Pₛ in the NMR ¹H signal for the given hydrocarbon mixture (ref. to FIG. 4) is plotted. In FIG. 4, the continuous curve depicts the function P_{S}(T), obtained through approximation of experimental points by using the equation

at N=2, ΔPₛ₁=71±2%, ΔPₛ₂=29±2%, T₀₁=−31.1±2.0° C., T₀₂=23.3±4.0° C. (3)

Analyzing the temperature dependence of the solid-body component fraction Pₛ in the NMR ¹H signal (ref. to FIG. 4), it is shown that the Pₛ fraction in the temperature range of −20° C. to +5° C. is virtually constant. In the said temperature range, tetracosane is in the crystal phase and the solid-body component fraction Pₛ in the NMR ¹H signal is predetermined only by tetracosane protons, since, in accordance with available source data, the melting point of decane and tetracosane (outside the mixture) is −30° C. and 50° C., respectively. As a result, the ΔPₛ₁ and ΔPₛ₂ corresponds to the contribution of decane and tetracosane, respectively, to NMR ¹H signal for the mixture comprising 30% tetracosane (C₂₄H₅₀) and 70% decane (C₁₀H₂₂).

The received melting temperatures of decane and tetracosane in the mixture are shifted to the lower temperature area as compared to available source data on their melting points outside of the mixture, according to which decane and tetracosane melt at temperatures of −30° C. and 50° C., respectively. The shift in the hydrocarbon melting temperatures towards the lower temperature area is explained by mixing of liquid and solid phases. For some two- and three-component mixtures, the shift of hydrocarbon melting temperatures towards the lower temperature area may be taken into consideration. For complex and multi-phase system (e.g., oil), the shift in the Type 1 phase transition temperature for each component of the mixture is defined experimentally and does not constitute an obstacle to the hydrocarbon mixture composition determination.

For more visible interpretation of the temperature dependence of the solid-body component's fraction Pₛ in the NMR ¹H signal for the given hydrocarbon mixture, a temperature dependence of a derivative from the function Pₛ(T) is calculated and a spectrum −dPₛ(T)/dT (ref. to FIG. 5) is obtained, in which peaks at −31.1±2.0° C. and 23.3±4.0° C. relate to decane and tetracosane, respectively. Integrals by peaks related to decane and tetracosane are equal to ΔPₛ₁ and ΔPₛ₂, respectively, and reflect data on the contribution of each component to the full NMR ¹H signal of the mixture.

Thereafter, a mass fraction of one of the components of the mixture is calculated, taking tetracosane as an example. Since the value ΔPₛ₂, brought about by tetracosane protons, is equal to 29±2%, then the following expression takes place:

$$\frac{S ( {C}_{24} {H}_{50} )}{S ( {C}_{10} {H}_{22} ) + S ( {C}_{24} {H}_{50} )} \cdot 100 \% = 29 , 0 \pm 2 , 0 \% , \qquad ( 1 )$$

where S—amplitude of the NMR ¹H signal of components of the mixture.

$$\frac{S ( {C}_{24} {H}_{50} )}{S ( {C}_{10} {H}_{22} )} = \frac{N ( {C}_{24} {H}_{50} ) \cdot 50}{N ( {C}_{10} {H}_{22} ) \cdot 22} = \frac{v ( {C}_{24} {H}_{50} ) \cdot {N}_{A} \cdot 50}{v ( {C}_{10} {H}_{22} ) \cdot {N}_{A} \cdot 22} , \qquad ( 2 )$$

where N—number of molecules of the mixture components; v—quantity of substance in the mixture components; N_{A}—Avogadro number.

$$\frac{m ( {C}_{24} {H}_{50} )}{m ( {C}_{10} {H}_{22} )} = \frac{M ( {C}_{24} {H}_{50} ) \cdot v ( {C}_{24} {H}_{50} )}{M ( {C}_{10} {H}_{22} ) \cdot v ( {C}_{10} {H}_{22} )} \\ = \frac{22 \cdot M ( {C}_{24} {H}_{50} ) \cdot S ( {C}_{24} {H}_{50} )}{50 \cdot M ( {C}_{10} {H}_{22} ) \cdot S ( {C}_{10} {H}_{22} )} , \qquad ( 3 )$$

where m—mass of components in the mixture; M—molar mass of components in the mixture.

$$\{ \begin{matrix}M ( {C}_{24} {H}_{50} ) = ( 12 \cdot 24 + 1 \cdot 50 ) / = 338 / \\ M ( {C}_{10} {H}_{22} ) = ( 12 \cdot 10 + 1 \cdot 22 ) / = 142 / ,\end{matrix} \qquad ( 4 )$$

From the equations (1-4), it's easy to get the value of the tetracosane mass fraction in the mixture:

$$\frac{m ( {C}_{24} {H}_{50} )}{m ( {C}_{10} {H}_{22} ) + m ( {C}_{24} {H}_{50} )} \cdot 100 \% = 29 , 96 \pm 2 , 0 \% , \qquad ( 5 )$$

The received values of the tetracosane mass fraction in the mixture (29.96±2.0%) perfectly coincides with its initial value (30%).

What is claimed is:

1. A method for defining a content of liquid and solid phase components in a hydrocarbon mixture, comprising the steps of:
collecting at least one sample of the hydrocarbon mixture;
measuring a series of the hydrocarbon mixture's free inductance decrement by nuclear magnetic resonance method;
determining a solid component fraction Pₛ in the NMR ¹H signal at a temperature, at which this value was measured, by analyzing each free inductance decrement curve;
plotting a temperature dependence of the solid component fraction Pₛ in the NMR ¹H signal on the basis of the received values; and
determining the content of solid and/or liquid phase components in the hydrocarbon mixture on the basis of the temperature dependence.

2. The method of claim 1, wherein the content of solid and/or liquid phase components in the hydrocarbon mixture is determined on the basis of the Pₛ value variation (ΔPₛᵢ), caused by a phase transition of the i^{th} component due to a heating or cooling process, by attributing the ΔPₛᵢ value to the associated components of the mixture.

3. The method of claim 1, wherein series of the hydrocarbon mixture's free inductance decrement curves are measured within a temperature range of −150° C. to +150°.
